(19) United States
(12) Patent Application Publication
(10) Pub. No.: US 2018/0249206 A1
(43) Pub. Date: Aug. 30, 2018

(54) SYSTEMS AND METHODS FOR PROVIDING INTERACTIVE VIDEO PRESENTATIONS

(71) Applicant: COOLIX.ME LTD., Shilo (IL)

(72) Inventor: Elyakim Drori, Shilo (IL)

(21) Appl. No.: 15/905,860

(22) Filed: Feb. 27, 2018

Related U.S. Application Data
(60) Provisional application No. 62/463,960, filed on Feb. 27, 2017.

(51) Int. Cl. H04N 21/44; H04N 21/8545; H04N 21/472; H04N 21/431; H04N 21/4788

(52) U.S. Cl. CPC H04N 21/44008; H04N 21/8545; H04N 21/4788; H04N 21/4312; H04N 21/472

(57) ABSTRACT

Video platform systems and methods for providing interactive video presentations for digital environments. Video content analysis may be performed on video clips allowing end-users to create interactive shoppable videos and to enable immediate and easy—“point of sales”—purchases by touching the product as seen on screen during a video clip. A system video editor or video producer may control the video display, determining when the interactive content is added to the currently viewed video clip and further to coordinate with the actual display.

### FIELD

The disclosure herein relates to providing video presentations. In particular the disclosure relates to systems and methods for providing a video platform operable to provide interactive video presentations for digital environments.

### BACKGROUND

Streaming media and online video (OLV), refers to multimedia concurrently received by and presented to an end-user while being delivered by a provider. Streaming is a well-established technology since the late 1980s or early 1990s when computers had the hardware and software that was capable of playing audio and displaying video. The advancement of technology provided a CPU powerful enough to render video, and a data bus wide enough to transmit video. Yet, consumption of streaming media has increased significantly over recent years, with online viewers using various digital platforms, such as TVs, computers, laptops, tablets, smartphones, handheld devices and the like.

Live streaming, the delivery of Internet content in real-time, as events happen, much as live television broadcasts its contents over the airwaves via a television signal is constantly advancing. For example, Facebook introduced recently a video streaming service, Facebook Live, to allow Facebook users to include their own “reactions” when someone is broadcasting. Similarly, YouTube for example, purchased by Google in 2006, announced their live streaming software application recently.

Providing video content on mobile devices, such as for advertising, may blend two common approaches. The first comprises pre-stitching adverts into the current content. The second based on dynamic advertisement insertion, wherein advertisements are inserted at run-time while the media is being streamed. Dynamic advertisement insertion gives operators the flexibility to insert context-based advertisements, for example depending on the user's geographic location, the program content, the user's preferences, and/or any other suitable criteria.

Irrespective of the method of providing advertising, any advertising content may be considered by the viewer to be an intrusion. A viewer may switch to another program during an advertisement, move away from the active video screen, or close the video session altogether.

Although presentations, such as advertisements, tutorials, webinars and the like, commonly presented in video form using video clips, but such video clips are generally prepared in advance for passive viewing with no user interaction. Specifically, OLV needs to be end-user initiated and run prior to a piece of video content. As such, the video clips are typically not interactive at all or, at best, may serve as links to external websites, screens or other forms, which are disconnected from the prepared video clip.

The need remains therefore, for a seamless interactive video presentation platform. The invention described herein addresses the above-described needs.

### SUMMARY

The current disclosure addresses various aspects of an interactive video platform operable to provide advanced user experience to the end-user viewing video on various communication devices.

According to one aspect of the presently disclosed subject matter, there is an interactive video platform operable to perform video content analysis of at least one video clip, said interactive video platform comprising an interactive video front-end sub-system in communication with a video back-end sub-system, the video back-end sub-system comprising: a video content analyzer operable to perform automated analysis of the at least one video clip; a video logic interface to provide an interfacing layer for a third party software module to connect with the video platform logic component; and a video loader operable to load and download the at least one video clip. The interactive video front-end sub-system comprises: a media player comprising a processing unit operable to display the at least one video clip and provide a desirable interactive user experience for an end-user. The interactive video platform is operable to generate an interactive video layer, enabling the end-user to communicate with the associated video content to provide an interactive video connected user experience.

As appropriate, the video content analyzer is operable to: perform video clip related context analysis to identify at least one recognizable product item; provide the at least one video clip interactive functionality for the at least one recognizable product item; and communicate with a third party product database via the interfacing layer, for example, to enable commercial digital transactions.

As appropriate, the video back-end sub-system may further comprises a video effect (VFX) server-side generator operable to activate a video generation function to generate at least one visual effect. Further, the at least one visual effect may be a pre-defined video effect.

In some embodiments, the interactive video front-end sub-system further comprises a video editor, the video editor operable: to communicate with said video effect (VFX) generator and associate the at least one visual effect with the at least one video clip. The video editor is further operable to provide a selection of the pre-defined video effect; to determine the pre-defined video effect parameters, and to associate the pre-defined video effect with the at least one video clip.

As appropriate, the interactive video platform further comprises a learning mechanism comprising a knowledge repository, the learning mechanism operable to generate a preferences file and continuously update user-viewing preferences.

As appropriate, the video content analyzer is operable to split the at least one video clip into a grid of smaller sub-clips and further operable to identify and replace in real-time parts of the grid according to a request of the end-user.

Additionally, the interactive front-end sub-system is operable to receive a user input via the at least one hotspot to trigger an interactive overlay operable to emulate the at least one video clip with the same appearance.

Another aspect of the disclosure is to teach a method for use in an interactive video platform. The method is operable to perform video content analysis of at least one video clip where the interactive video platform comprising: a media player operable to display the at least one video clip and provide a desirable interactive user experience for an end-user, and a processing unit operable to load the at least one video clip. The processing unit is further operable to receive at least one controllable input. The platform also includes a video effect (VFX) generator operable to add at least one visual effect to the at least one video clip; and a video editor operable to communicate with said video effect (VFX) generator and associate the at least one visual effect with the at least one video clip to create an interactive presentation. The interactive video platform is operable to generate at least one interactive video layer being triggered in real-time time upon receiving the at least one controllable input.

As appropriate, the receiving of a controllable input is selected from a group consisting of: a video system-editor controlled input, a time-based controlled input and combinations thereof.

As appropriate, the at least one interactive video layer comprises at least one interactive element selected from at least one of a group consisting of: a frame-view, an image-view, a text-view, a button, an associated hotspot and combinations thereof. Accordingly, the at least one interactive element is operable to respond actively to a user input and further provide at least one selectable option. Furthermore, the at least one interactive video layer comprising at least one of a group consisting of: HTML code, CSS (Cascade Style Sheet) elements, a scripting language and combinations thereof configured to allow the end-user to interact with the video content.

Another aspect of the disclosure is to teach a method for use in an interactive video platform operable to provide a video content interactive presentation to a plurality of end-users associated with at least one video clip, in an improved manner. The interactive video platform comprises a video content management sub-system controlled by a video system editor in communication with a video management server comprising a video content analyzer, a video loader and a video logic interface. The method comprising the steps of: presenting a user interface (UI) via which the video system editor is able to select at least one video clip for display by the media player, receiving a selection by the video system editor of at least one digital interactive overlay associated with the at least one video clip and transmitting the at least one digital interactive overlay viewable to said plurality of end-users.

As appropriate, the video content interactive presentation may be displayable on at least one media player associated with each of the plurality of end-users.

As appropriate, the at least one digital interactive overlay comprises at least one displayable element configured to receive at least one user input indication.

Optionally, the at least one displayable element is selected from a group consisting of: an image view, a button view, a text view, a frame, a rounded frame and combinations thereof.

Another aspect of the disclosure is to teach a method for use in an interactive video platform operable to interact with a video content interactive presentation on a video player of a communication device associated with an end-user, in an improved manner, the interactive video platform comprises a video editing system controlled by a video system editor in communication with a video management back-end system, the method comprising the steps of: presenting at least one video clip onto the digital media player of the communication device; receiving a video stream updates to the at least one video clip; receiving at least one digital interactive overlay displayable over the at least one video clip to form a personalized user interface (UI) via which the end-user is able to communicate with the interactive video platform; and transmitting at least one user indication to the video management backend system.

As appropriate, the step of transmitting at least one user indication further comprises sharing at least one item with a social network.

As appropriate, the step of transmitting at least one user indication further comprises transmitting at least one interactive module associated with said end-user.

### BRIEF DESCRIPTION OF THE DRAWINGS

For a better understanding of the embodiments and to show how it may be carried into effect, reference will now be made, purely by way of example, to the accompanying drawings.

With specific reference now to the drawings in detail, it is stressed that the particulars shown are by way of example and for purposes of illustrative discussion of selected embodiments only, and are presented in the cause of providing what is believed to be the most useful and readily understood description of the principles and conceptual aspects. In this regard, no attempt is made to show structural details in more detail than is necessary for a fundamental understanding; the description taken with the drawings making apparent to those skilled in the art how the several selected embodiments may be put into practice. In the accompanying drawings:

FIG. 1A is a schematic block diagram illustrating the main elements of an interactive video platform distribution for performing video content analysis of at least one video clip, according to one embodiment of the current disclosure;

FIG. 1B is a schematic block diagram illustrating the main elements representing a basic video client-server architecture of an interactive video platform;

FIG. 2 is a schematic block diagram of the main components of another possible video management client-server architecture, according to one embodiment of the current disclosure;

FIG. 3 is a schematic block diagram of the main components of a possible video back-end sub-system, according to one embodiment of the current disclosure;

FIG. 4 is a schematic block diagram of the main components of a possible video content management sub-system, according to one embodiment of the current disclosure;

FIG. 5A is a schematic view presented on a mobile device display providing an interactive user experience;

FIG. 5B is a possible view presented on a mobile device display providing an interactive user experience for an advertising video clip;

FIG. 5C is another possible view presented on a tablet device display providing an interactive user experience for an end-user viewing a fashion show;

FIG. 6 is a flowchart indicating selected steps for playing a video clip enhanced with user selected effects;

FIG. 7A is a flowchart indicating selected steps of a method for generating a desired video effect from a list of pre-configured video effects;

FIG. 7B a flowchart indicating selected steps of a method for presenting at least one video clip onto an associated media player;

FIG. 7C is a flowchart indicating selected steps of a method for generating at least one time-framed video clip; and

FIG. 7D is a flowchart indicating selected steps of a method for displaying at least one time-framed video clip by the associated media player.

### DETAILED DESCRIPTION

Aspects of the present disclosure relate to systems and methods for providing interactive video presentations.

Accordingly, a platform is introduced allowing an end-user to create unique and interactive shoppable videos for products and services to enable immediate and easy—“point of sales”—purchases, simply by touching the product as seen on screen during a video clip. It will be appreciated that such a platform represents a revolutionary way to deliver content and advertising, enabling the viewer to smoothly interact with the advertising content within the original video context.

In various embodiments of the disclosure, one or more tasks as described herein may be performed by a data processor, such as a computing platform or distributed computing system for executing a plurality of instructions. Optionally, the data processor includes or accesses a volatile memory for storing instructions, data or the like. Additionally or alternatively, the data processor may access a non-volatile storage, for example, a magnetic hard-disk, flash-drive, removable media or the like, for storing instructions and/or data.

It is particularly noted that the systems and methods of the disclosure herein may not be limited in its application to the details of construction and the arrangement of the components or methods set forth in the description or illustrated in the drawings and examples. The systems and methods of the disclosure may be capable of other embodiments, or of being practiced and carried out in various ways and technologies.

Alternative methods and materials similar or equivalent to those described herein may be used in the practice or testing of embodiments of the disclosure. Nevertheless, particular methods and materials are described herein for illustrative purposes only. The materials, methods, and examples are not intended to be necessarily limiting.

Interactive video is a type of interactive content that creates engagement by layering information on top of an existing video clip/session. This allows end-users to actively engage with video content rather than just passively watch the video content. Such interactive activity may be used for providing advanced type of dynamic shopping experience, watching actively real-time events, polls and surveys, assessments, tutorial videos, information and explanatory videos and the like. Specifically, the introduced technology provides for adding of dynamic information layers in real-time, on top of live video. Additionally or alternatively, it may be applied to pre-recorded video sessions.

Existing interactive video technology is commonly based upon a pre-configured session, determining the presentation time-line behavior at specific time spots throughout a video session. Thus, a viewer of a video session may receive frames of information at pre-configured times. Further, TV media technology allows addition of information layers which are static and do not provide any interactive functionality. For example, a sporting event may be provided with statistics, or a league table which is static with no dynamic abilities.

It is specifically noted that the introduced technology generates interactive formats allowing more value added for the end-user by creating a two-way dialogue—enabling a personalized, user-focused experience from start to finish in real-time. Thus, a system video editor is in control of a video session and may use a content management layer to feed content into existing video session in real-time. Accordingly, when the system video editor presses a button to add an interactive layer, all end-users currently watching the video session receive the updated display in real-time, as determined by the system video editor.

The system video editor may view the same video content as the other end-users and may add dynamic content synchronized with the current session. For example, if the video presentation is of a fashion show, the system video editor may “inject” an overlay of picture(s) of the dress of a model with a “buy me” button, to allow the end-user to respond, interactively, if he wishes to buy the dress.

### DESCRIPTION OF THE EMBODIMENTS

It is noted that such a platform may be integrated into an e-commerce system and method. For example, the end-user may choose to connect the editor to a third party e-commerce service or upload and manage his inventory on our system. The end-user chooses a template and the system automatically integrate the products with the interactive layer. This can be made on both server and client side.

Furthermore the platform may enable real time pixels and frames manipulation. In order to reduce loading time and size of videos, the system and method may be operable to change specific frames or/and pixels of a movie in real time.

For example, this may be achieved by splitting the movie into a grid of smaller movies. The platform may recognize which parts of the grid needs to be replaced by a request of the end-user and will replace it in real time.

Where appropriate, a dynamic Artificial Intelligence User Interface (AI UI) may be provided for interactive shoppable videos. Accordingly, as a viewer is exposed to the media player, the system may generate a file operable to explore the end-user's preferences. After gathering enough data on the same segment the system may decide how to maximize conversion from this specific profile, generating relevant user experience, hotspots, interactive screens and items suggestions on top of the video. Showing relevant information in order to better drive that person to buy or convert.

The platform may further enable automatic item recognition for shoppable videos. This may be achieved by the system being operable to detect items from the stock of the end-user. These items may examine the uploaded video and cross data with the stock to generate automatic hotspots, interactive screens with dynamic user interface and tags for those items.

The methods described herein may be extended to support automatic shoppable video for interactive “360 round videos”. The platform may provide a 360 round video player operable to recognize items from database on top of 360 round video. The platform may further place trackable hot spots on top of such items and create dynamic UI for 360 round videos. Where appropriate, volumetric pixels may serve as active pixels enabling such interactivity.

Accordingly, a 360 VFX server side generator may allow the end-user to choose a pre-defined effect using the editor. The server generates the 360 round video effect and the final result is an interactive 360 round video with effects triggers. When hitting a trigger the effect is shown smoothly without a delay.

A method for generating the interactive video clip may include steps including:

Sectioning the video clip into sub-clips,

Associating each sub-clip with a prepared interactive loop,

Mapping each frame of the sub-clip to a corresponding destination frame on the interactive loop,

Preloading all interactive loops before playing the video clip, and

When an end-user (the viewer) activates an activation frame, the display switches to the corresponding destination frame of the associated interactive loop and continues displaying the interactive loop.

In other embodiments, a system and method is disclosed for allowing a video producer to trigger interactive components to be presented above a video (live stream video/online video) in real time for all online viewers.

Each interactive component may include a set of code such as HTML/CSS/JavaScript allowing the end-user (viewer) to interact with the content once pushed into the view.

For example the interactive component can be an image of a product and a buy button below, clicking on the button will open a web browser with a specified link, the image & buy button will only appear on the screen when the advertiser trigger's the component.

This feature may allow an advertiser to control the timing when each component/layer is loaded above video.

According to still other embodiments, a system and method is disclosed for allowing interaction with social networks presented above a video (live stream video/online video).

Content may be pushed into the social network (Facebook, Twitter, Instagram) once the video producer has triggered it.

Thus, the method enables the displaying of content such as textual content, image content or the like from the social network feed above the video in real-time.

Thus, real time distribution (sharing content) is possible from the interactive layer from the video (live stream video/online video) into multiple social platforms.

Furthermore, the system and method is provided for allowing end-users to upload video comments and push them to all viewers of a video (live stream video/online video) in real time.

Again in other systems and methods of the disclosure, the video state may be set, for instance a live stream video might have three states: “before the show”, “show currently running”, “after the show”.

Where multiple states are provided, for each of those states the video may show a different interactive layer allowing the end-user to have multiple engagements throughout the show, where appropriate.

Optionally, the state of the video may be set manually by the video producer and updated to all viewers in real time. Alternatively or additionally an automatic selection of the state may be performed possibly according to preferred defaults.

### Video Platform Architecture:

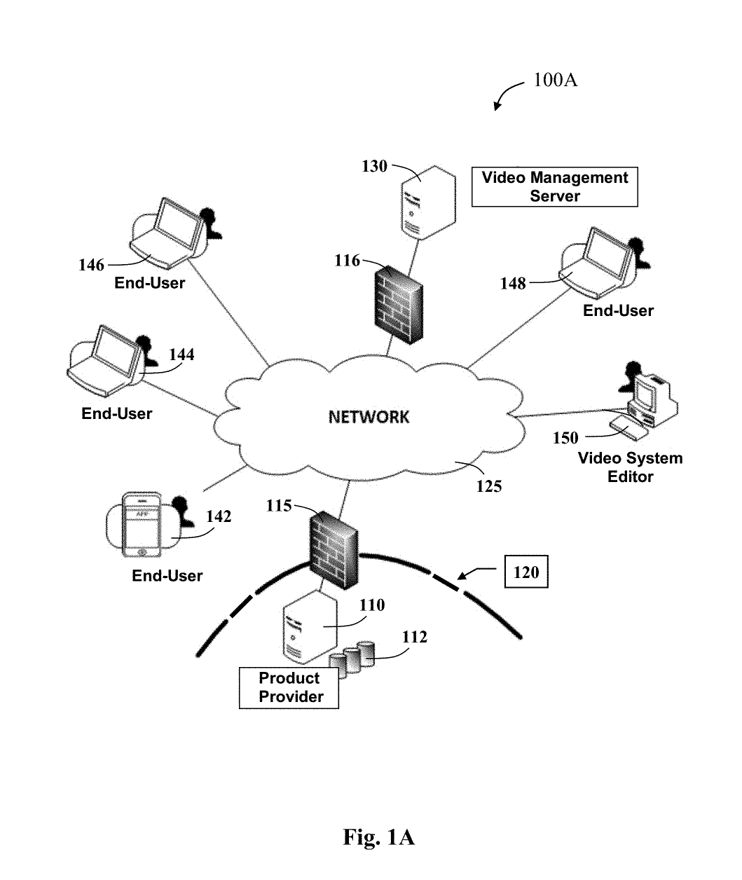

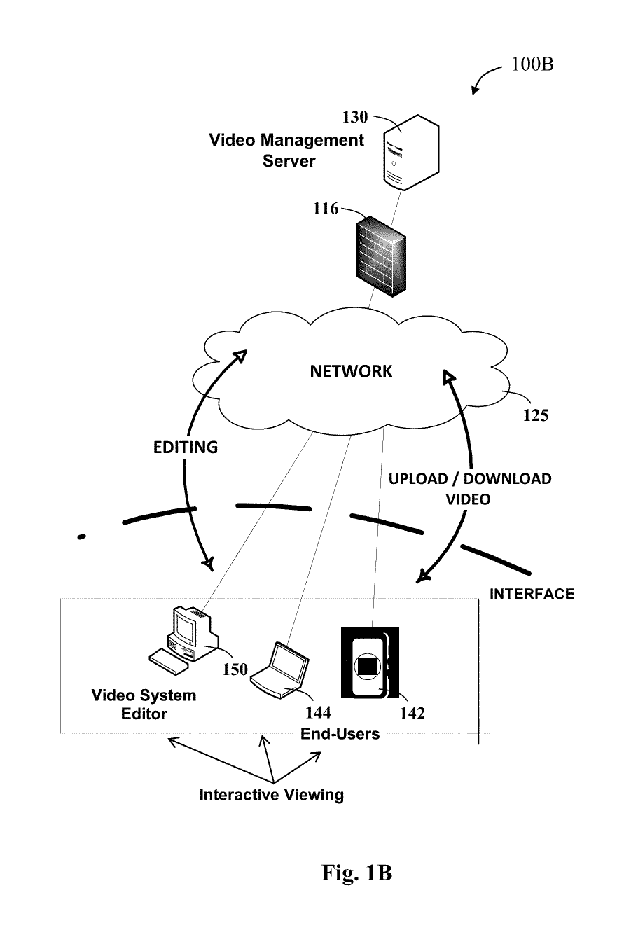

Reference is now made to FIG. 1A, there is provided a general schematic block diagram representing a possible interactive video platform distribution, which is generally indicated at 100A, for performing video content analysis of at least one video clip, using a client-server architecture, according to one embodiment of the current disclosure. The interactive video platform distribution 100A consists of a video back-end sub-system comprising a video management server 130, possibly behind a firewall system 116, and in communication with a set of computing devices, each device associated with an individual end-user and includes an interactive video front-end sub-system. The interactive video front-end sub-system includes a media player (not shown) comprising a processing unit operable to display at least one video clip and client side software. The video management server 130, controlled by a system video editor 150, is operable to perform automated control and monitoring at least one request of an end-user using a communication device such as tablet 142, laptop computers 144, 146 and 148, for example, display at least one video clip. The video management server 130 is in communication, via the external network 125, generally and may communicate with a cloud infrastructure environment 120 associated with various providers, partners and the like. The cloud infrastructure environment 120 may be associated, for example, with a product server 110, possibly behind a firewall system 115, a data repository 112 and a set of associated applications (not shown).

The system video editor 150 is operable to control in real-time the interactive video content associated with the video clip, determine a set of interactive video elements, presentation timing and may further configure associated video platform environment and determine the various video platform parameters.

Reference is now made to FIG. 1B, there is provided a general schematic block diagram representing a basic video client-server architecture, which is generally indicated at 100B, for performing video content analysis of at least one video clip and allowing interactive video viewing, according to one embodiment of the current disclosure. The video client-server architecture 100B consists of a video back-end sub-system comprising a video management server 130, possibly behind a firewall system 116, and in communication with a set of computing devices, each device associated with an individual end-user and includes an interactive video front-end sub-system. The interactive video front-end sub-system includes a media player (not shown) comprising a processing unit operable to display at least one video clip and a video client side software. The end-users may use a communication device such as tablet 142 and laptop computer 144 and may further communicate with the video back-end sub-system via the video management server 130 for editing various video associated parameters, uploading/downloading video clips (using optionally, a dedicated video loader) or perform, for example, shoppable interactions following the video advertising clip associated information.

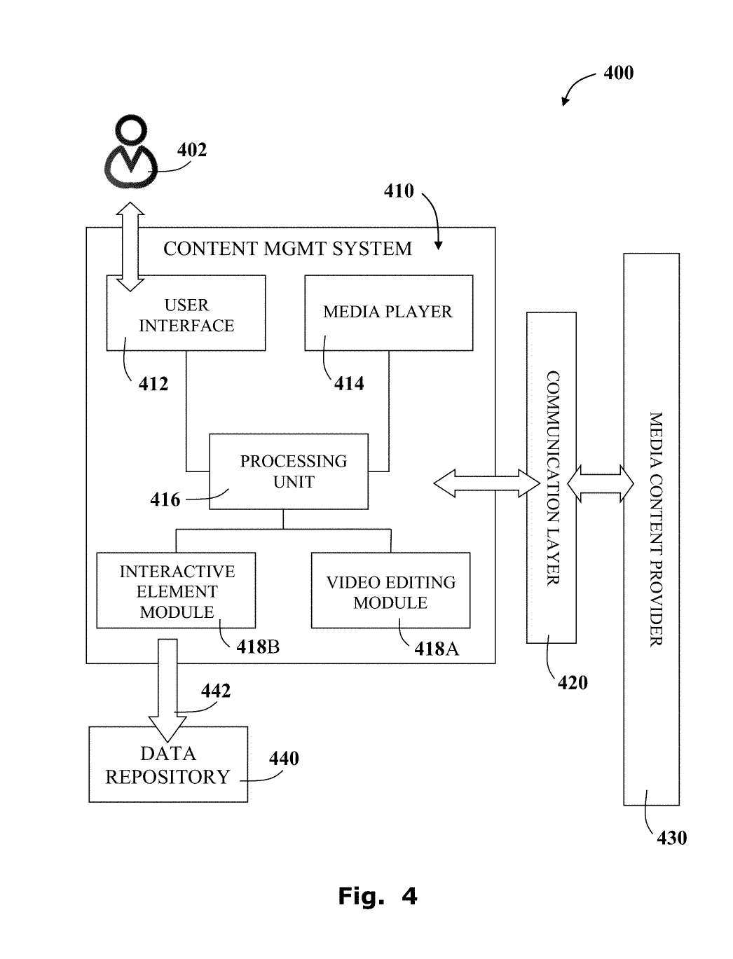

Further, the system video editor 150 is operable to control in real-time, via a content management system (FIG. 4), the interactive video content associated with the video clip being viewed by end-users of devices 142 and 144 by presenting at least one interactive video overlay to allow user interactive response.

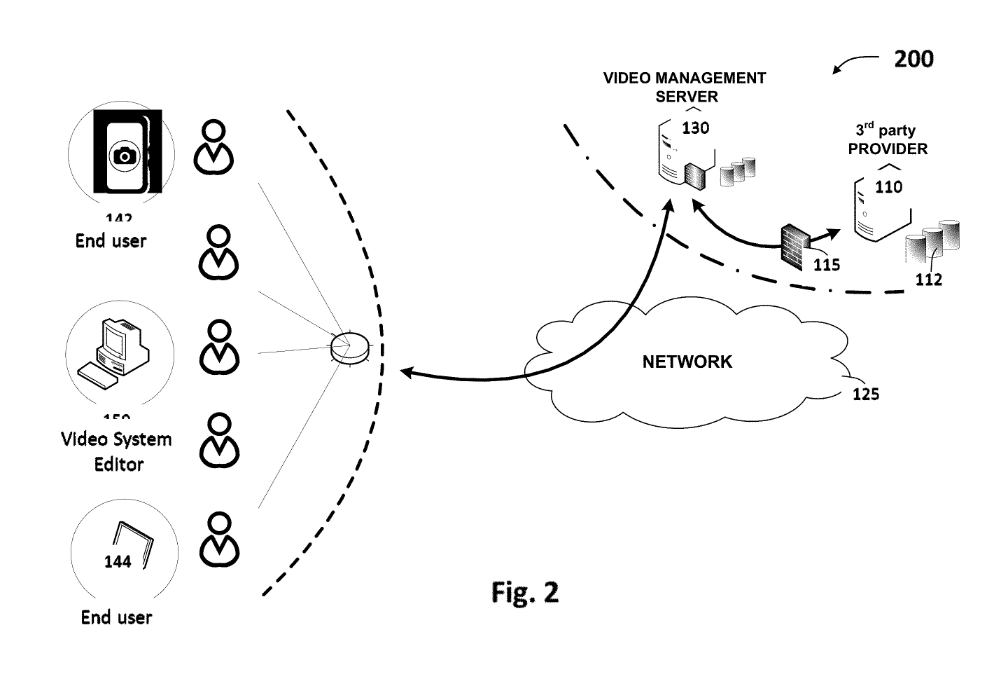

Reference is now made to FIG. 2, there is provided a general schematic block diagram representing a possible video management client-server architecture, which is generally indicated at 200. The video management client-server architecture 200, operable for performing video content analysis of at least one video clip, and further communicating with a 3^{rd} party provider associated with merchandise appearing in the video advertising clip, according to one embodiment of the current disclosure. The video management client-server architecture 200 consists of a video management server 130 in communication with a set of computing devices, each device includes a video client side software and associated with an individual end-user. The end-users may use a communication device such as tablet 142 and laptop computer 144 may communicate with the video management server 130 responding interactively with a video advertising clip for further purchase of an item appearing in the video advertising clip.

It is noted that the item video appearing in the video advertising clip is considered as a recognizable item by the video management platform, as part of the associated video content analysis.

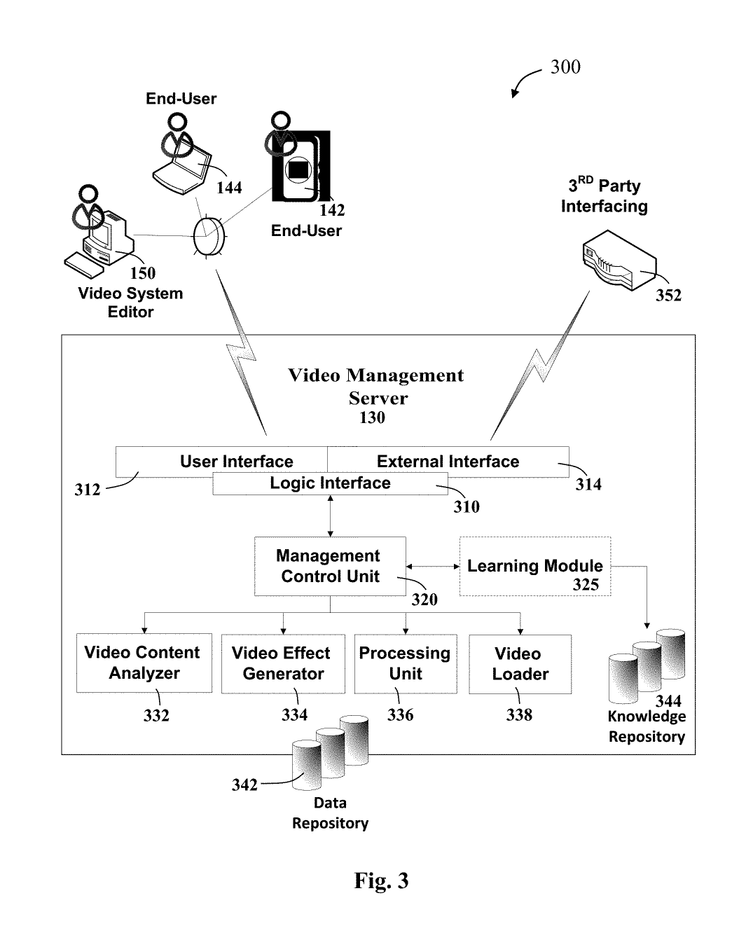

Reference is now made to FIG. 3, there is provided a general schematic block diagram representing a possible video back-end sub-system, which is generally indicated at 300. The video back-end sub-system 300, comprising a video management server, is operable to perform video content analysis of at least one video clip. The back-end sub-system 300 may communicate in real-time with the video viewers (via communication devices 142, 144), and further communicate with a third party entity (via a third party interfacing 352), such as a merchandise provider appearing in the video clip, according to one embodiment of the current disclosure.

It is noted that the system video editor 150 is operable to trigger transmission of at least one interactive overlay being presented over the video clip displayed on viewers' communication devices.

The video back-end sub-system 300 includes a video management server 130 in communication with a set of communication devices, via a logic interface 310 comprising a user interface 312 and an external interface 314. The video back-end sub-system 300 further includes a management control unit 320, a video content analyzer 332, a video effect generator 334, a processing unit 336, a video loader 338 and a data repository 342.

Optionally, the video back-end sub-system 300 includes a learning module 325 operable to generate a preferences file and continuously update user-viewing preferences. The learning module 325 may use gathered information stored in a knowledge repository 344.

### Video Content Management:

Reference is now made to FIG. 4, there is provided a general schematic block diagram representing a possible video content management sub-system, which is generally indicated at 400, for transmitting a video interactive overlay by a system video editor 402. The video content management system 400 includes a user interface 412, a media player 414, a processing unit 416, an interactive element module 418A and a video editing module 418B and may further communicate with a data repository 440 via a communication channel 442.

The video content management system 400 may further provide a communication layer 420 to enable communication with a media content provider.

It is noted that the video content management system 400 provides the system video editor 402 with a tool set for creating an interactive video overlay via the video editing module 418A and the interactive element module 418B. The interactive video overlay may include various graphical elements to provide the end-user with a personalized visual interface and enable the end-user to interact with the system.

Additionally, the system video editor 402 is viewing the same video content as the other end-users, via the media player 414, and may add dynamic content synchronized with the current session.

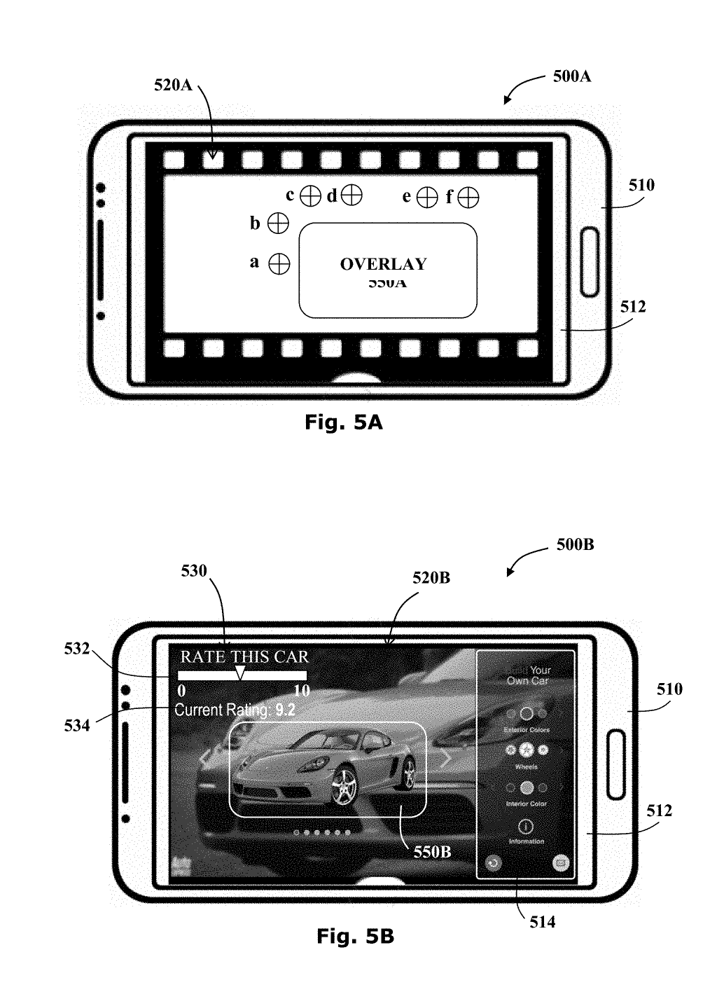

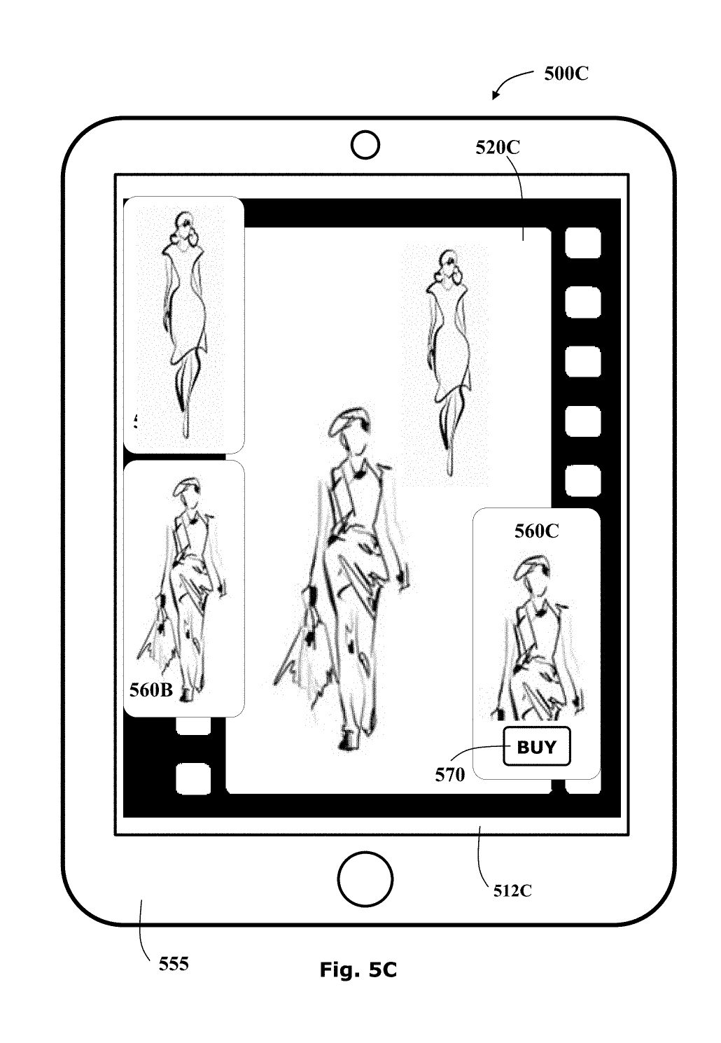

Reference is now made to FIG. 5A, there is provided a general schematic view presented on a mobile device display 512, which is generally indicated at 500A, playing an interactive video clip 520A and providing an interactive user experience. The view 500A presented includes a mobile device 510, an associated device screen 512, a video clip 520A, an overlay 550A and a set of hotspots (a-f) configured to allow interactions of the end-user with the video platform back-end sub-system.

The overlay 550A and the set of hotspots (a-f) may appear on the mobile device display 512 once triggered by a system video editor (FIG. 1A item 150, FIG. 4 item 402) using a content management sub-system (FIG. 4 item 410), commonly synchronizing the display with the video clip 520A with the video content of the overlay 550A.

It is noted that the overlay 550A may be an image, a video sub-clip, a text line, a textual paragraph and the like and may be interactive in itself.

Alternatively, the end-user may touch the device screen 512 while the video clip 520A is displayed, to trigger the appearance of the overlay 550A and the set of hotspots.

It is further noted that where appropriate, activation of a hotspot by one user may update a field in the interactive overlay for other users viewing the same video. For example, a real time survey or poll may provide a hotspot prompting for a real-time response from the end users with the results of such a survey or poll being aggregated and presented back to the end users via the overlay.

Reference is now made to FIG. 5B, there is provided an example of a car advertising interactive view presented on a mobile device display 512, which is generally indicated at 500B, playing an interactive video clip 520B of a saleable racecar, providing an interactive user experience. The view 500B presented is an exemplified actual view of FIG. 5A and includes an advertising video clip 520B of a racecar, an overlay 550B displaying the car according to user selections made via the set of hotspot marked 514 as well as an interactive poll 530.

For example, the end-user may touch various hotspots to receive further car information, change color of racecar, select interior color, type of wheels and request further information and more. User selections are then refreshed in the overlay 550B displaying the sub-clip video according to request.

The interactive poll 530 may be provided to allow end users to provide feedback in real time for example via a slide bar 532, radio buttons, text fields or the like. The feedback may be aggregated and displayed back to all users and video manager as a dynamic result field 534 in real time.

Reference is now made to FIG. 5C, there is provided an example of a fashion show interactive view presented on a tablet display 512C, which is generally indicated at 500C, playing an interactive video clip 520C of a fashion show, providing an interactive user experience. The view 500C presented is an exemplified interactive view, and includes a fashion show video clip 520C, an overlay 560A of a model, an overlay 560B of another model and an overlay 560C includes a partial view of 560B and a “BUY” button 570. Each overlay is controllable by the system video editor (FIG. 1A item 150, FIG. 4 item 402) and may be triggered using the content management sub-system (FIG. 4 item 410), commonly synchronized by the system video editor with the fashion show itself. The overlay 560C may be triggered by the end-user pressing with his finger, for example, on the overlay 560B, indicating an interest.

It is noted that the interactive video platform is operable to trigger a controllable input by the system video editor, via the content management sub-system (FIG. 4 item 410), transmitted to the front-end sub-system indicating transmissions of overlay data. The input signal may be selected from a group consisting of: a video system-editor controlled input, a time-based controlled input and combinations thereof.

### Video Visual Effects:

Visual effects (abbreviated VFX) are the processes, by which imagery created and/or manipulated outside the context of a live action shot, commonly are done in post-production, through the power of a computer. As opposed to special effects (often abbreviated as SFX) which are illusions or visual tricks used in the film, television, theatre, video game and simulator industries to simulate that the imagined events ‘in camera,’ meaning they actually, physically happen.

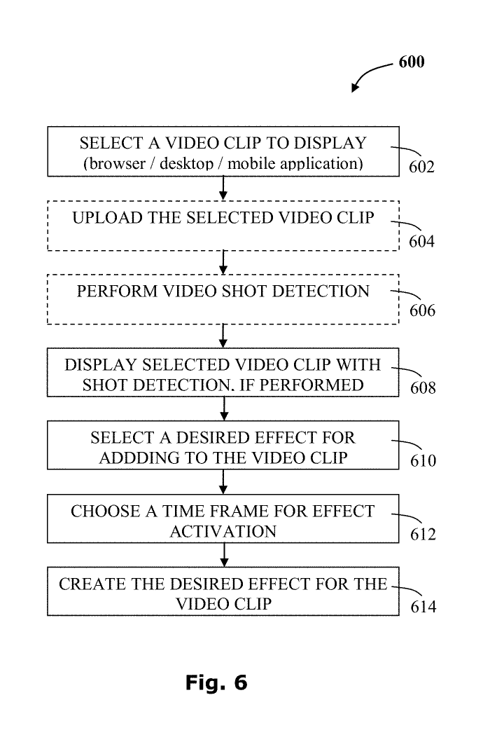

Reference is now made to FIG. 6, there is provided a flowchart representing selected actions illustrating a possible method configured for using a platform to enhance a video clip with selected video effects, which is generally indicated at 600, for creating an interactive presentation.

A video effects (VFX) server side generator may allow the end-user to choose a pre-defined effect using the editor. An end-user may input video effect parameters and the VFX server may use a video generation function to generate the effect. This may result in an interactive video with one or more effect triggers. The trigger may be associated with spatial or temporal windows with the video clip or with particular trigger sets of activation pixels or activation frames occurring during the video clip. When activating a trigger, the effect may be displayed smoothly without a delay.

Additionally, it may be noted that the interactive video front-end sub-system may include a video editor component operable to communicate with the video effect (VFX) generator and associate at least one visual effect with the at least one video clip.

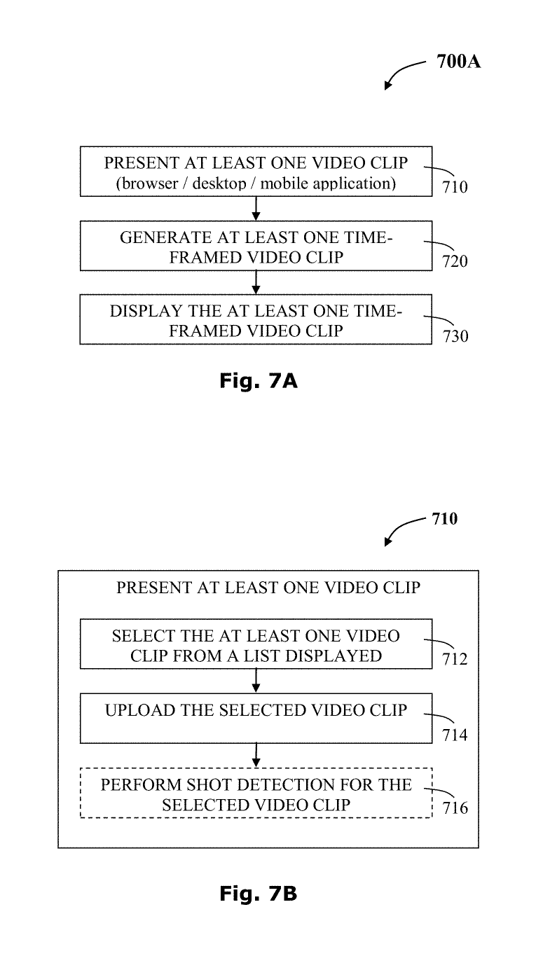

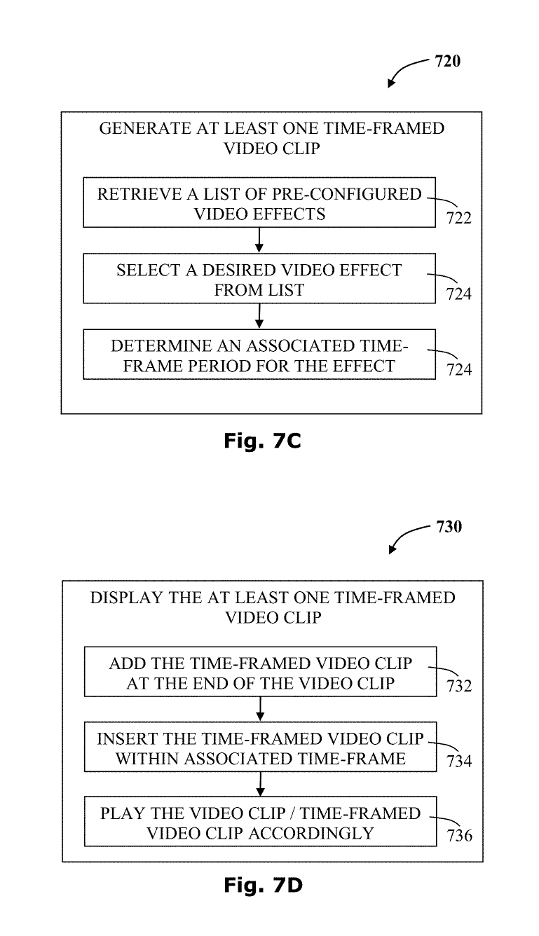

The details of the steps are presented in FIGS. 7A-D

Reference is now made to FIG. 7A, there is provided a flowchart representing selected actions illustrating a possible method configured for a video system editor, which is generally indicated at 700A, for generating a desired video effect from a list of pre-configured video effects.

The method 700A may be triggered by a video system editor executing a software application installed on his/her system device.

In step 710—presenting at least one video clip onto an associated media player;

In step 720—generating at least one time-framed video clip; and

In step 730—displaying at least one time-framed video clip by the associated media player.

Reference is now made to FIG. 7B, there is provided a flowchart representing selected actions illustrating a possible method configured for a video system editor, which is generally indicated at 710, for presenting at least one video clip onto an associated media player.

The method 710 may be triggered by a video system editor executing a software application installed on his/her system device.

In step 712—selecting the at least one video clip from a list displayed onto the media player;

In step 714—uploading the selected at least one video clip onto said video management server; and, optionally the method 710 comprising,

In step 716—performing shot detection associated with the at least one video clip.

It is noted that shot detection is associated with video processing and refers to the automated detection of transitions between shots in digital video with the purpose of temporal segmentation of videos.

Reference is now made to FIG. 7C, there is provided a flowchart representing selected actions illustrating a possible method configured for a video system editor, which is generally indicated at 720, for generating at least one time-framed video clip.

The method 720 may be triggered by a video system editor executing a software application installed on his/her system device.

In step 722—retrieving a list of pre-configured video effects;

In step 724—selecting a desired video effect from said list of pre-configured video effect; and

In step 726—determining an associated time-frame period.

Reference is now made to FIG. 7D, there is provided a flowchart representing selected actions illustrating a possible method configured for a video system editor, which is generally indicated at 730, for displaying at least one time-framed video clip by the associated media player.

A system video editor, executing a software application installed on his/her system device, may trigger the method 730.

In step 732—adding the at least one time-framed video clip at the end of the at least one video clip; alternatively,

In step 734—inserting the at least one time-framed video clip within said associated time-frame period; and

In step 736—displaying the whole new at least one video clip including at least one time-framed video clip.

Technical and scientific terms used herein should have the same meaning as commonly understood by one of ordinary skill in the art to which the disclosure pertains. Nevertheless, it is expected that during the life of a patent maturing from this application many relevant systems and methods will be developed. Accordingly, the scope of the terms such as computing unit, network, display, memory, server and the like are intended to include all such new technologies a priori.

As used herein the term “about” refers to at least ±10%.

The terms “comprises”, “comprising”, “includes”, “including”, “having” and their conjugates mean “including but not limited to” and indicate that the components listed are included, but not generally to the exclusion of other components. Such terms encompass the terms “consisting of” and “consisting essentially of”.

The phrase “consisting essentially of” means that the composition or method may include additional ingredients and/or steps, but only if the additional ingredients and/or steps do not materially alter the basic and novel characteristics of the claimed composition or method.

As used herein, the singular form “a”, “an” and “the” may include plural references unless the context clearly dictates otherwise. For example, the term “a compound” or “at least one compound” may include a plurality of compounds, including mixtures thereof.

The word “exemplary” is used herein to mean “serving as an example, instance or illustration”. Any embodiment described as “exemplary” is not necessarily to be construed as preferred or advantageous over other embodiments or to exclude the incorporation of features from other embodiments.

The word “optionally” is used herein to mean “is provided in some embodiments and not provided in other embodiments”. Any particular embodiment of the disclosure may include a plurality of “optional” features unless such features conflict.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween. It should be understood, therefore, that the description in range format is merely for convenience and brevity and should not be construed as an inflexible limitation on the scope of the disclosure. Accordingly, the description of a range should be considered to have specifically disclosed all the possible sub-ranges as well as individual numerical values within that range. For example, description of a range such as from 1 to 6 should be considered to have specifically disclosed sub-ranges such as from 1 to 3, from 1 to 4, from 1 to 5, from 2 to 4, from 2 to 6, from 3 to 6 etc., as well as individual numbers within that range, for example, 1, 2, 3, 4, 5, and 6 as well as non-integral intermediate values. This applies regardless of the breadth of the range.

It is appreciated that certain features of the disclosure, which are, for clarity, described in the context of separate embodiments, may also be provided in combination in a single embodiment. Conversely, various features of the disclosure, which are, for brevity, described in the context of a single embodiment, may also be provided separately or in any suitable sub-combination or as suitable in any other described embodiment of the disclosure. Certain features described in the context of various embodiments are not to be considered essential features of those embodiments, unless the embodiment is inoperative without those elements.

Although the disclosure has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present disclosure. To the extent that section headings are used, they should not be construed as necessarily limiting.

The scope of the disclosed subject matter is defined by the appended claims and includes both combinations and sub combinations of the various features described hereinabove as well as variations and modifications thereof, which would occur to persons skilled in the art upon reading the foregoing description.

What is claimed is:

1. An interactive video platform operable to perform video content analysis of at least one video clip, said interactive video platform comprising an interactive video front-end sub-system in communication with a video back-end sub-system,
said video back-end sub-system comprising:
a video content analyzer operable to perform automated analysis of the at least one video clip;
a video logic interface to provide an interfacing layer for a third party software module to connect with the video platform logic component; and
a video loader operable to load and download the at least one video clip, and
said interactive video front-end sub-system comprising:
a media player comprising a processing unit operable to display the at least one video clip and provide a desirable interactive user experience for an end-user;
an interactive video layer generator operable to generate an interactive video layer, enabling the end-user to communicate with the associated video content to provide an interactive video connected user experience.

2. The interactive video platform of claim 1, wherein said video content analyzer is operable to:
perform video clip related context analysis to identify at least one recognizable product item;
provide the at least one video clip interactive functionality for the at least one recognizable product item; and
communicate with a third party product database via said interfacing layer to enable commercial digital transactions.

3. The interactive video platform of claim 1, wherein said video back-end sub-system further comprising a video effect (VFX) server-side generator operable to activate a video generation function to generate at least one visual effect.

4. The interactive video platform of claim 3, wherein the at least one visual effect is a pre-defined video effect.

5. The interactive video platform of claim 4, wherein said interactive video front-end sub-system further comprising a video editor component, said video editor component operable:
to communicate with said video effect (VFX) generator and associate the at least one visual effect with the at least one video clip;
to provide selection of said pre-defined video effect;
to determine said pre-defined video effect parameters; and
to associate said pre-defined video effect with the at least one video clip

6. The interactive video platform of claim 1, further comprising a learning mechanism comprising a knowledge repository, said learning mechanism operable to generate a preferences file and continuously update user-viewing preferences.

7. The interactive video platform of claim 1, wherein said video content analyzer is operable to split the at least one video clip into a grid of smaller sub-clips and further operable to identify and replace in real-time parts of the grid according to a request of the end-user.

8. The interactive video platform of claim 5, wherein said interactive front-end sub-system is operable to receive a user input via the at least one hotspot to trigger an interactive overlay operable to emulate the at least one video clip with the same appearance.

9. The interactive video platform of claim 1, further comprising:
a video effect (VFX) generator operable to add at least one visual effect to the at least one video clip; and
a video editor component operable to communicate with said video effect (VFX) generator and associate the at least one visual effect with the at least one video clip to create an interactive presentation;
wherein said processing unit is operable to load the at least one video clip and further operable to receive at least one controllable input from said interactive video platform; and
wherein an interactive video layer generator is operable to generate at least one interactive video layer being triggered in real-time time upon receiving said at least one controllable input.

10. The interactive video platform of claim 9, wherein said receiving a controllable input is selected from a group consisting of: a video system-editor controlled input, a time-based controlled input and combinations thereof.

11. The interactive video platform of claim 9, wherein said at least interactive video layer comprising at least one interactive element selected from at least one of a group consisting of: a frame-view, an image-view, a text-view, a button, an associated hotspot and combinations thereof.

12. The interactive video platform of claim 11, wherein said at least one interactive element is operable to respond actively to a user input and further provide at least one selectable option.

13. The interactive video platform of claim 9, wherein said at least one interactive video layer comprising at least one of a group consisting of: HTML code, CSS (Cascade Style Sheet) elements, a scripting language and combinations thereof configured to allow the end-user to interact with the video content.

14. A method for use in an interactive video platform operable to provide a video content interactive presentation to a plurality of end-users associated with at least one video clip, in an improved manner,
said interactive video platform comprises a video content management sub-system controlled by a video system editor in communication with a video management server comprising a video content analyzer, a video loader and a video logic interface, said method comprising the steps of:
presenting a user interface (UI) via which said video system editor is able to select the at least one video clip for display by said media player;
receiving a selection by said video system editor of at least one digital interactive overlay associated with the at least one video clip; and
transmitting said the at least one digital interactive overlay viewable to said plurality of end-users.

15. The method of claim 14, wherein said video content interactive presentation displayable on at least one media player associated with each of said plurality of end-users.

16. The method of claim 14, wherein said at least one digital interactive overlay comprising at least one displayable element configured to receive at least one user input indication.

17. The method of claim 16, wherein said at least one displayable element is selected from a group consisting of: an image view, a button view, a text view, a frame, a rounded frame and combinations thereof.

18. A method for use in an interactive video platform operable to interact with a video content interactive presentation on a video player of a communication device associated with an end-user, in an improved manner,
said interactive video platform comprises a video editing system controlled by a video system editor in communication with a video management back-end system, said method comprising the steps of:
presenting at least one video clip onto the digital media player of the communication device;
receiving a video stream updates to the at least one video clip;
receiving at least one digital interactive overlay displayable over the at least one video clip to form a personalized user interface (UI) via which the end-user is able to communicate with the interactive video platform; and
transmitting at least one user indication to the video management backend system.

19. The method of claim 18, wherein said step of transmitting at least one user indication further comprising sharing at least one item with a social network.

20. The method of claim 18, wherein said step of transmitting at least one user indication further comprising transmitting at least one interactive module associated with said end-user.
